(19) United States
(12) Patent Application Publication
(10) Pub. No.: US 2012/0279697 A1
(43) Pub. Date: Nov. 8, 2012

(54) THERMAL INTERFACE MATERIAL WITH PHENYL ESTER

(76) Inventors: Deborah Forray, San Diego, CA (US); My Nhu Nguyen, Poway, CA (US)

(21) Appl. No.: 13/469,679

(22) Filed: May 11, 2012

Related U.S. Application Data
(63) Continuation of application No. PCT/US2010/055924, filed on Nov. 6, 2010.
(60) Provisional application No. 61/261,152, filed on Nov. 13, 2009.

(51) Int. Cl. C09K 5/14; F28F 21/00

(52) U.S. Cl. 165/185; 252/79; 252/76

(57) ABSTRACT

A thermal interface material comprises a phenyl ester and a thermally conductive filler. The material optionally contains an epoxy resin derived from nutshell oil or an epoxidized dimer fatty acid.

### CROSS-REFERENCE TO RELATED APPLICATIONS

This application is a continuation of International Patent Application No. PCT/US2010/055924 filed Nov. 9, 2010, which claims priority to U.S. Provisional Patent Application No. 61/261,152 filed Nov. 13, 2009, the contents of both of which are incorporated herein by reference.

### FIELD OF THE INVENTION

This invention relates to a thermally conductive material that is utilized to transfer heat from a heat-generating electronic device to a heat sink that absorbs and dissipates the transferred heat.

### BACKGROUND OF THE INVENTION

Electronic devices containing semiconductors generate a significant amount of heat during operation. The level of heat generated is related to the performance of the semiconductor, with less highly performing devices generating lower levels of heat. In order to cool the semiconductors, which must be cooled in order to obtain appreciable performance, heat sinks are affixed to the device. In operation, heat generated during use is transferred from the semiconductor to the heat sink where the heat is harmlessly dissipated. In order to maximize the heat transfer from the semiconductor to the heat sink, a thermally conductive material, known as a thermal interface material (TIM), is utilized. The TIM ideally provides intimate contact between the heat sink and the semiconductor to facilitate the heat transfer.

There are various types of TIMs currently used by semiconductor manufacturers, all with their own advantages and disadvantages. For those semiconductors generating relatively lower levels of heat than high performing semiconductors, a preferred thermal solution is the use of a thermal gel containing aluminum as the conductive material. These materials provide adequate thermal conductivity (3 to 4 W/m-K), but they can be susceptible to delamination under stress.

Thus, it would be advantageous to provide a thermal interface material that is easy to handle and apply, yet also provides a highly adequate thermal conductivity and reliable performance.

### SUMMARY OF THE INVENTION

This invention is a composition for use as a thermal interface material in a heat-generating, semiconductor-containing device.

In one embodiment, the composition comprises aluminum metal particles and a phenyl ester. In another embodiment, the composition further comprises an epoxidized dimer fatty acid. In a third embodiment, the composition further comprises an epoxy resin derived from nutshell oil. In all embodiments, a catalyst is optional. The metal particles are substantially devoid of added lead. The presence of the phenyl ester as the main resin component makes the composition more flexible, thus preventing cracking and increasing the contact between the heat sink and the semiconductor. Thus, the presence of the phenyl ester acts to inhibit thermal degradation and consequently works to keep the thermal impedance stable over time.

The use of the epoxidized dimer fatty acid, and in some embodiments additionally of the epoxy resin derived from nut oil, provides an optimum range of modulus for the thermal interface material. These epoxies form a gel-like or tacky mass that physically keeps the solder particles connected and in place within the thermal interface material, thus keeping the thermal impedance stable over time.

In another embodiment, this invention is an electronic device containing a heat-generating component, a heat sink and a thermal interface material according to the above description.

### BRIEF DESCRIPTION OF THE DRAWING

FIG. 1 is a side view of an electronic component having a heat sink, a heat spreader, and thermal interface material.

### DETAILED DESCRIPTION OF THE INVENTION

The thermal interface material of the present invention may be utilized with any heat-generating component for which heat dissipation is required, and in particular, for heat-generating components in semiconductor devices. In such devices, the thermal interface material forms a layer between the heat-generating component and the heat sink and transfers the heat to be dissipated to the heat sink. The thermal interface material may also be used in a device containing a heat spreader. In such a device, a layer of thermal interface material is placed between the heat-generating component and the heat spreader. and a second layer of thermal interface material is placed between the heat spreader and the heat sink.

In one embodiment, the phenyl esters are selected from the group consisting of

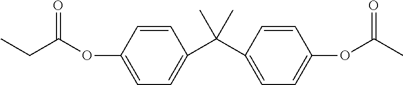

propionate diacetate

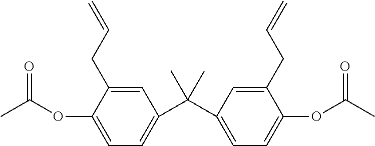

bisphenol A diallyl diacetate

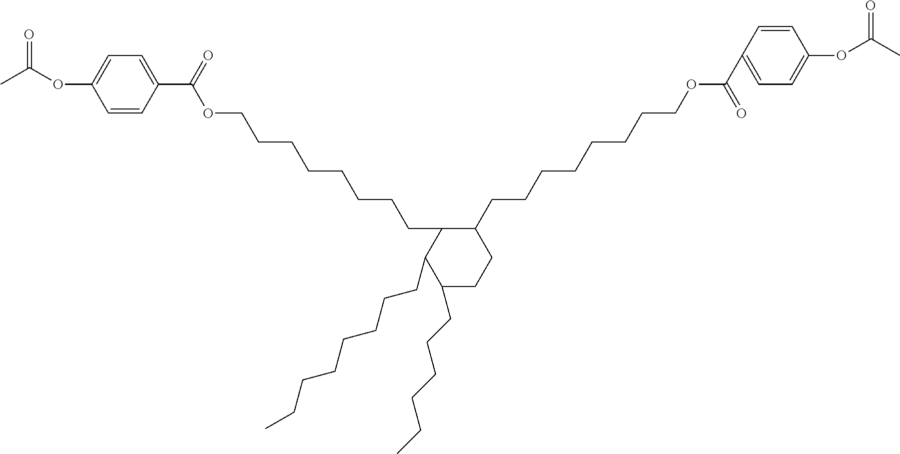

dimer diacetate

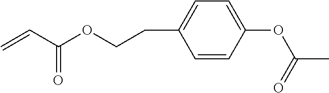

mono-functional acetate

and

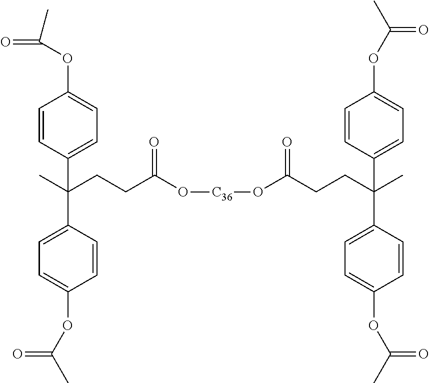

tetra-functional acetate.

The phenyl ester will be present in the composition within a range of 5 to 35 weight percent based on the total weight of the composition.

The epoxidized dimer fatty acids are the reaction products of dimer fatty acids and epichlorohydrin. In one embodiment, the epoxidized dimer fatty acid has the following structure in which R is a 34 carbon chain represented as C₃₄H₆₈:

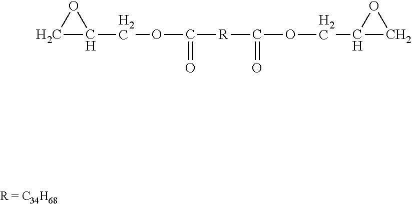

It is commercially available from CVC Chemical in New Jersey.

The epoxy resin derived from nutshell oil comprises one or both of the following structures:

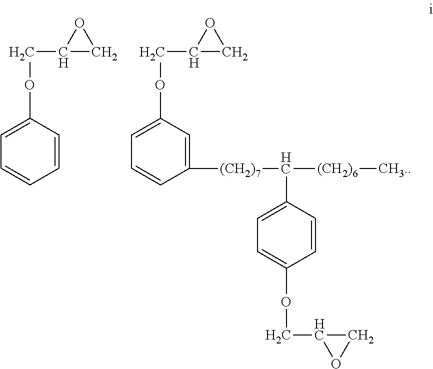

These resins are commercially available from Cardolite Corporation in New Jersey. Either the monofunctional epoxy or the difunctional epoxy or a blend of any ratios is equally effective within the TIM composition.

The use of a catalyst for the epoxy functionality is optional, but any catalyst known in the art suitable for polymerizing or curing epoxy functionality may be used. Examples of suitable catalysts include peroxides and amines. When present, the catalyst will be used in an effective amount; in one embodiment, an effective amount ranges from 0.2 to 2% by weight of the composition.

Aluminum metal particles are typically used in thermal interface materials due to their lower cost compared to solder or silver, although silver particles may also be present. An exemplary aluminum metal powder is commercially available from Toyal America in Illinois. In one embodiment the metal powder has an average particle size of about 1-10 microns. In one embodiment, the metal powder will be present in the composition in a range from 50 to 95 weight percent of the total composition.

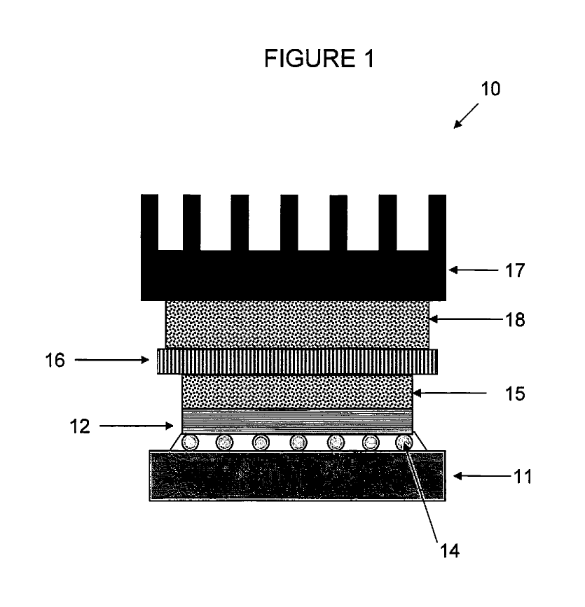

In one embodiment illustrated in FIG. 1, an electronic component 10 utilizing two layers of thermal interface materials comprises a substrate 11 that is attached to a silicon die 12 via interconnects 14. The silicon die generates heat that is transferred through thermal interface material 15 that is adjacent at least one side of the die. Heat spreader 16 is positioned adjacent to the thermal interface material and acts to dissipate a portion of the heat that passes through the first thermal interface material layer. Heat sink 17 is positioned adjacent to the heat spreader to dissipate any transferred thermal energy. A thermal interface material is located between the heat spreader and the heat sink. The thermal interface material 18 is commonly thicker than the thermal interface material 15.

### EXAMPLES

Compositions were prepared to contain the components in weight percent shown in the below Table. The inventive samples are identified as A, B, C, and D. The comparative samples are identified as E, F and G. They all consist of a liquid reactive mixture of polymer resins and aluminum powder.

The TIM compositions were tested for thermal conductivity by measuring the resistance within a TIM composition disposed between a silicon die and a copper plank. The silicon die was heated and the heat input measured using a combination of a voltage and current meter. The heat traveled through the TIM to the copper heat sink, and the temperature on the heat sink was read by a thermocouple. Resistance was calculated from these values.

The results are reported in the Table and show that the inventive compositions containing the phenyl ester, compared to the comparative compositions, exhibited stable and lower thermal impedance, especially after the reliability tests of baking and thermal cycling. Low thermal impedance is needed for heat dissipation, and it is also important that thermal impedance remains stable over time, thereby assuring a longer life for the ultimate device in which it is used.

The results further show that the inventive compositions containing the phenyl ester exhibited a lower modulus that did not increase after exposure to high temperature. Low modulus is needed so that the compositions remain soft and flexible, which results in better thermal conductivity. This is in contrast to the comparative compositions, which all showed a significant increase in modulus after high temperature baking. These comparative compositions exhibited high thermal degradation, becoming hard and brittle, which ultimately would result in interfacial delamination of the TIM to its substrate.

| | SAMPLE ID AND COMPOSITION IN PERCENT BY WEIGHT | | | | | | |
|---|---|---|---|---|---|---|---|
| COMPONENT | A | B | C | D | E | F | G |
| Epoxidized | | | 2.5 | | | 14.5 | 7.25 |
| nutshell oil | | | | | | | |
| Epoxidized | 5 | 5 | 2.5 | | 14.5 | | 7.25 |
| dimer fatty | | | | | | | |
| acid | | | | | | | |
| X-Diacetate | 14.9 | 15 | 14.9 | 14.9 | | | |
| phenyl ester | | | | | | | |
| ECE861 | | | | | | | |
| 2-Phenyl-4- | 0.1 | | 0.1 | 0.1 | 0.5 | 0.5 | 0.5 |
| methyl | | | | | | | |
| imidazole | | | | | | | |
| Aluminum | 80 | 80 | 80 | 80 | 80 | 80 | 80 |
| powder | | | | | | | |

VISCOSITY (at room temperature) (kcps)

| | | | | | | | |
|---|---|---|---|---|---|---|---|
| Cone-and- | 100000 | 100000 | 90000 | 50000 | 28000 | 17000 | 24000 |
| Plate @ 5 RPM | | | | | | | |

THERMAL IMPEDANCE (taken at room temperature after conditions stated)
(C · cm²/Watt)

| | | | | | | | |
|---|---|---|---|---|---|---|---|
| Before cure | 0.224 | 0.22 | 0.24 | 0.24 | 0.22 | 0.21 | 0.22 |
| Cured at 150 C. | 0.18 | 0.17 | 0.18 | 0.17 | 0.2 | 0.2 | 0.2 |
| for 1 hr | | | | | | | |
| Baked at 150 C. | 0.2 | 0.19 | 0.2 | 0.19 | 0.4 | 0.36 | 0.4 |
| for 100 hrs | | | | | | | |

MODULUS (taken at room temperature after conditions stated) (Pa)

| | | | | | | | |
|---|---|---|---|---|---|---|---|
| Cured | 35000 | 25000 | 31000 | 29000 | 25000 | 500 | 1500 |
| 100 hrs at | 44000 | 28000 | 37000 | 33000 | 160000 | 50000 | 85000 |
| 125 C. | | | | | | | |
| 100 hrs at | 45000 | 30000 | 40000 | 35000 | 350000 | 210000 | 240000 |
| 150 C. | | | | | | | |
| 100 hrs at | 38000 | 24000 | 30000 | 30000 | 125000 | 23000 | 60000 |
| 121 C. and | | | | | | | |
| 100% RH | | | | | | | |
| 125 cycles | 35000 | 27000 | 33000 | 28000 | 100000 | 15000 | 50000 |
| from - 55 C. | | | | | | | |
| to 125 C. | | | | | | | |
| MSL L3 260 C. | 35000 | 30000 | 36000 | 34000 | 250000 | 150000 | 200000 |

We claim:

1. A thermal interface material comprising:
(a) a phenyl ester selected from the group consisting of 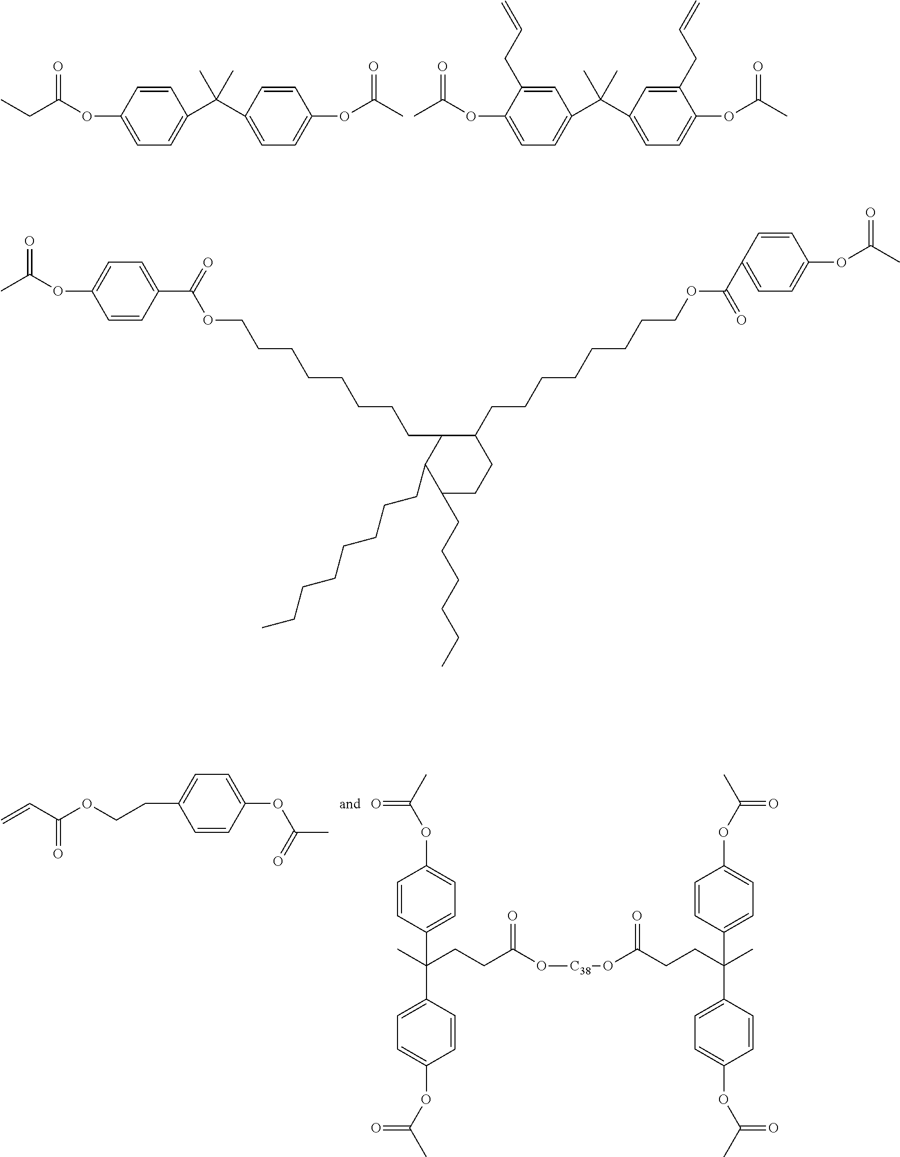
(b) thermally conductive filler.

2. The thermal interface material of claim 1 in which the thermally conductive filler is aluminum powder.

3. The thermal interface material of claim 1 further comprising:
(c) an epoxidized dimer fatty acid.

4. The thermal interface material of claim 3 in which the epoxidized dimer fatty acid has the structure:
in which

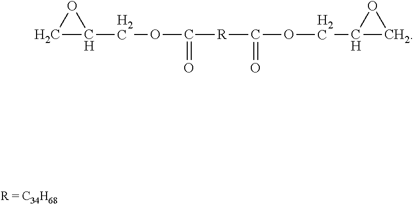

5. The thermal interface material of claim 3 further comprising an epoxy resin derived from nutshell oil.

6. The thermal interface material of claim 5 in which the epoxy resin derived from nutshell oil comprises one or both of the following structures:

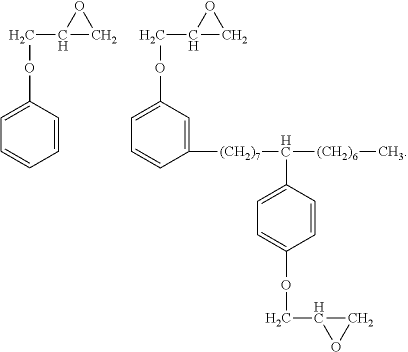

7. The thermal interface material of claim 1 in which the phenyl ester is present in an amount ranging from 5 to 35 weight percent of the total composition

8. The thermal interface material of claim 3 in which the epoxidized dimer fatty acid is present in an amount ranging from 1 to 10 weight percent of the total composition.

9. The thermal interface material of claim 5 in which the epoxy resin derived from nutshell oil is present in an amount ranging from 1 to 10 weight percent of the total composition.

10. The thermal interface material of claim 1 in which the thermally conductive filler is present in an amount ranging from 50 to 95 weight percent of the total composition.

11. An assembly comprising a semiconductor chip; a heat spreader; and the thermal interface material of claim 1 there between.

12. An assembly comprising a heat spreader; a heat sink; and the thermal interface material of claim 1 there between.
